(19) United States
(12) Patent Application Publication
(10) Pub. No.: US 2008/0098340 A1
(43) Pub. Date: Apr. 24, 2008

(54) Method for Designing Block Placement and Power Distribution of Semiconductor Integrated Circuit

(75) Inventor: Sung Hwan Oh, Seoul (KR)

Correspondence Address: HARNESS, DICKEY & PIERCE, P.L.C., P.O. BOX 828, BLOOMFIELD HILLS, MI, 48303, US

(73) Assignee: Entasys Design, Inc., Seoul (KR)

(21) Appl. No.: 11/720,162

(22) PCT Filed: Nov. 25, 2005
(86) PCT No.: PCT/KR05/03985

§ 371 Date: May 24, 2007

(30) Foreign Application Priority Data
Dec. 6, 2004 (KR) 10-2004-0101701

(51) Int. Cl. G06F 17/50

(52) U.S. Cl. 716/8

(57) ABSTRACT

The present invention relates to a method for designing initial placement of functional blocks and designing power distribution network of a semiconductor integrated circuit in the next stage of architecture level design of integrated circuit, which estimates the area and the quantity of power consumption of functional blocks and integrated circuit using design specifications of the functional blocks constructing the integrated circuit, that is, interconnection between functional blocks and an estimated size of the functional blocks which is determined in an architecture level design process. The present invention enables initial functional block placement in consideration of power consumption of the functional blocks and analyze reliability of power distribution network even prior to detailed circuit design.

### FIELD

The present invention relates to a method for designing a semiconductor integrated circuit, and more particularly, to a method for designing block placement and power distribution network of a semiconductor integrated circuit, which designs functional block placement and structure of power distribution network in a micro architecture design process in consideration of power consumption and reliability of power distribution network of a system-on-chip, to thereby perform analysis of reliability of power distribution network through estimation of a voltage drop and current density.

### BACKGROUND

As finer process geometry of integrated circuits are adopted and the scale of an integrated circuit is increased, the power consumption of a single chip is rapidly increased and the revision of layout design and circuit modification caused by an excess voltage drop detected in post layout verification process are frequently made. In the design of ASIC (Application Specific Integrated Circuit) products requiring shorter design turn around time, particular, the time required for re-design and the excessive consumption of design resources are fatal obstacle factors in securing product compatibility.

FIG. 1 is a systematic diagram of a conventional semiconductor integrated circuit design flow. Referring to FIG. 1, the design flow includes an architecture design process 10 of a semiconductor integrated circuit, a circuit design process 20 of a logic function block including register transfer level (RTL) design 21 to define the function behavior of the function block, a gate level design 22 for designing a gate level circuit connectivity and a logical function simulation 23 of the function block, a layout design process 30 including floor plan design 31 according to the architecture of the design, gate level cell placement 32 and signal wire routing 33, a simulation process 40 of performing timing and power analysis after the logic design 20 and layout design 30, a process 50 of carrying out physical aware analysis of a voltage drop (IR-Drop) of power distribution network, current density (EM), cross-talk and noise after the simulation process 40, and a physical verification process 60 of verifying the overall design.

As described above, the design of the conventional semiconductor integrated circuit performs architecture design, simultaneously carries out the logic design process 20 and layout design 30, and then performs the simulation process 40 and physical verification process 50.

As the complexity and density of semiconductor integrated circuits are rapidly increased, serious problems are caused by the excessive voltage drop and current density are generated. Verification of reliability of the power distribution network is carried out in the physical verification process 50 in the prior part. However, if a reliability problem of a power distribution network is founded after logic design and layout design is completed, the layout design should be re-executed to correct the problem. Re-designing of layout, which consumes most of the design turn around time results in many problems.

### SUMMARY

### Technical Problem

Accordingly, the present invention provides a functional block level power distribution modeling method for estimating and preventing a design error caused by an excessive voltage drop and excessive current density of power distribution network, which can be verified and corrected only in the final design verification process in the conventional SOC (system on chip) and ASIC (Application Specific Integrated Circuit) design method, in an initial floor plan process, a method of optimizing functional block placement in consideration of power consumption and voltage drop of chip level, and a method of designing block placement and power distribution network of a semiconductor integrated circuit using a method of estimating power consumption of a functional block and a chip in micro architecture level design stage.

The present invention models the quantity of power consumption and distribution of physical positions of power-consuming elements required for circuit power distribution network design using specifications of functional blocks constructing an integrated circuit, that is, connectivity with external functional blocks and an estimated size, in an architecture level design process corresponding to the first step of a semiconductor integrated circuit design process to enable chip level initial placement in consideration of power consumption of the function block even before the design of detailed circuits and design of detailed power distribution, thereby minimizing unnecessary modification of a power distribution network.

To analyze power consumption of an integrated circuit and a voltage drop of a power distribution network, layout information including placement and interconnections of logical primitive cells is required.

The present invention enables the design of a power distribution network in consideration of a voltage drop and current density of the power distribution network in the initial step of an integrated circuit design process to remarkably reduce a period of time required for designing an integrated circuit using a standard cell library in order to prevent the defects of products due to an excessive voltage drop of the power distribution network and excess of maximum current density allowed for a part of the power distribution network, which can be verified only in the later step of the integrated circuit design process.

The present invention provides a design method of carrying out physical placement of functional blocks using a virtual element and forming a virtual power consumption model using probability and statistical techniques in order to estimate suitability and reliability of power distribution network of an integrated circuit. In addition, the present invention provides a method of dividing a functional block into lower blocks in order to make statistically meaningful circuit size of the block to estimate accurate power consumption of the lower blocks and estimating power consumption of the entire function block in consideration of interconnection of the divided lower blocks in the estimation of the function block and integrated circuit. Furthermore, the present invention provides a method of constructing and analyzing a virtual power distribution network to perform optimization of functional block placement, which is considering a voltage drop of power distribution network in a functional block placement process.

For this, the present invention includes 1) process of estimating average power consumption of functional blocks constructing an integrated circuit, 2) process of estimating power consumption of the entire integrated circuit, 3) functional block placement process for minimizing the entire area of the integrated circuit, complexity of interconnections among functional blocks and a voltage drop of the power distribution network caused by power consumption, 4) process of power distribution network routing for the entire integrated circuit, and 5) process of analyzing a voltage drop and current density of the power distribution network, using the estimated number of logic circuits and the number of input/output terminals, which determine the complexity of the functional blocks, and design information related to a semiconductor fabrication process, which determines electrical characteristics of the logic circuits.

Each of the processes of the present invention uses 1) output loading capacitance modeling method for each circuit type, which determines power consumption of lower logic elements constructing a function block, 2) method of modeling loading capacitance of signal lines connected between functional blocks, 3) modeling method for estimating a degree of voltage drop supplied to each functional block in functional block placement state, 4) method of modeling power consumption of a virtual logic element for internal power distribution of functional blocks in a process prior to a process of designing detailed circuits of the functional blocks, and 5) macro modeling method for hierarchically performing a voltage drop analysis of the power distribution network.

### Technical Solution

To accomplish the above object, according to an aspect of the present invention, there is provided a method for designing block placement and power distribution network of a semiconductor integrated circuit, which designs a semiconductor integrated circuit through logical circuit design after architecture design, and simulation and physical verification after layout design, wherein a power distribution network reliability estimation process, which models complexity of the inside of each of functional blocks constructing the integrated circuit based on functional block specifications, estimates power consumption of each functional block to design block placement and power distribution network for the entire chip, and analyzes the reliability of power distribution network, such as a voltage drop and current density of power distribution network according to loading capacitance modeling of each functional block to estimate and verify reliability of power distribution network, is performed after architecture design, and then layout design is carried out.

The reliability estimation process of power distribution network comprises the steps of: receiving functional block specification information, such as the number of inputs/outputs of functional blocks of an integrated circuit, the logical gate count of the functional blocks, average switching probability, an operating voltage, and frequency, which are set by architecture design; modeling complexity of signal lines of the functional blocks based on the functional block specification information; modeling an average length of the signal lines of the functional blocks based on the functional block specification information; modeling interconnection line capacitance of a unit length of the signal lines; calculating the total loading capacitance based on the signal line complexity, the average length, and the interconnection line capacitance of the unit length and estimating power consumption based on the total loading capacitance; designing functional blocks placement and power distribution network of the entire chip in consideration of a power consumption value of each functional block; modeling power consumption distribution of each function block based on switching probability distribution with respect to virtual elements of each function block; and analyzing a voltage drop and current density at each node of power distribution network based on power consumption of each functional block.

### DRAWINGS

Further objects and advantages of the invention can be more fully understood from the following detailed description taken in conjunction with the accompanying drawings, in which:

FIG. 1 is a systematic diagram for explaining a conventional semiconductor integrated circuit design method;

FIG. 2 is a systematic diagram for explaining a semiconductor integrated circuit design method according to the present invention;

FIG. 3 is a flow chart for explaining block placement and power distribution network design using power consumption estimation according to the present invention;

FIG. 4 illustrates interconnection of logic circuits constructing a detailed circuit of a functional block for explaining the present invention;

FIG. 5 is a graph showing distribution of output loading capacitance connected to the output of each of logic circuits constructing a functional block for explaining the present invention;

FIG. 6 illustrates placement of functional blocks constructing an integrated circuit and placement of power distribution network providing power to the functional blocks according to the present invention;

FIG. 7 illustrates macro-models of a power distribution network of functional blocks and a power distribution network of a corresponding block for explaining the present invention;

FIG. 8 illustrates a global network structure including a macro model of a power distribution network of functional blocks for explaining the present invention; and

FIG. 9 illustrates the concept of a global network structure having K functional blocks according to the present invention.

### DETAILED DESCRIPTION

### Best Mode

The present invention will now be described in detail in connection with preferred embodiments with reference to the accompanying drawings. For reference, like reference characters designate corresponding parts throughout several views.

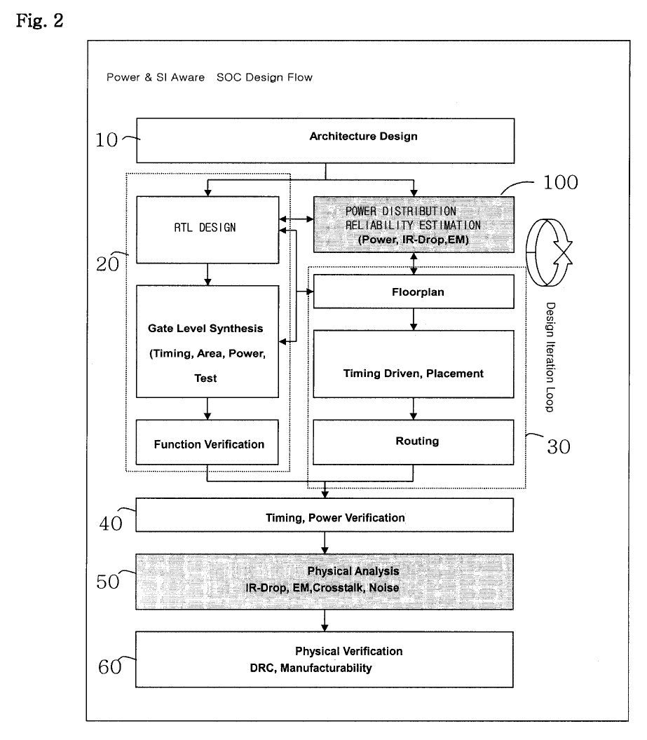

FIG. 2 is a systematic diagram for explaining a semiconductor integrated circuit design method according to the present invention. In the semiconductor integrated circuit design method according to the present invention, which includes a semiconductor integrated circuit architecture design process 10, a logical circuit design process 20, a layout design process 30, a simulation process 40, a process 50 of performing physical verification of a voltage drop IR-Drop, current density EM, crosstalk and noise of power distribution network, and a design verification process 60 of verifying the overall design, as shown in FIG. 2, the present invention solves a problem that the design process is repeated from the first step when modification is needed because the simulation process 40 and the physical verification process 50 of verifying reliability of power distribution network are carried out after the layout design 30.

For this, the present invention performs reliability estimation process 100 of a power distribution network right after the architecture design process 10, and then carries out the layout design process 30.

The reliability estimation process 100 of a power distribution network of the present invention models complexity of the inside of each functional block based on specifications of functional blocks constructing an integrated circuit, estimates power consumption of each functional block to design block placement and power distribution network for the entire chip, and analyzes reliability of power distribution network such as a voltage drop and current density of power distribution network according to modeling of power consumption of each functional block to estimate and verify reliability of power distribution network after the architecture design.

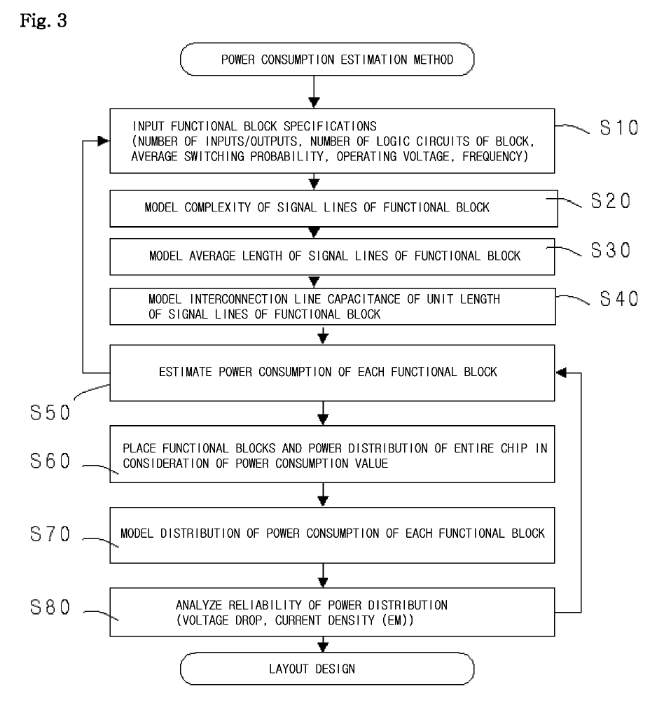

FIG. 3 is a flow chart for explaining block placement and power distribution network design using power consumption estimation according to the present invention. Referring to FIG. 3, the reliability estimation process of power distribution network includes a step S10 of receiving functional block specification information, such as the number of inputs/outputs of functional blocks of an integrated circuit, the number of logic gates in the functional blocks, average switching probability, an operating voltage, and frequency, which are set by architecture design, a step S20 of modeling complexity of signal lines of the functional blocks based on the functional block specification information, a step S30 of modeling an average length of the signal lines of the functional blocks based on the functional block specification information, a step S40 of modeling interconnection line capacitance of a unit length of the signal lines, a step S50 of calculating the total loading capacitance based on the signal line complexity, the average length, and the interconnection line capacitance of the unit length and estimating power consumption based on the total loading capacitance, a step S60 of designing functional blocks placement and power distribution network of the entire chip in consideration of a power consumption value of each functional block, a step S70 of modeling power consumption distribution of each function block based on switching probability distribution with respect to virtual logic gates of each function block, and a step S80 of analyzing a voltage drop and current density at each node of power distribution network based on power consumption of each functional block.

The reliability estimation process 100 of power distribution network according to the present invention receives function block specifications in the step S10. Specifically, the reliability estimation process 100 of power distribution network receives specification information including the number of inputs/outputs of functional blocks, the number of logic gates in the function blocks, average switching probability, an operating voltage, and frequency.

To estimate power consumption of functional blocks, complexity of the signal lines of the functional blocks is modeled in the step S20, an average length of the signal lines of the functional blocks is modeled in the step S30, and interconnection line capacitance of a unit length of the signal lines is modeled in the step S40. Modeling of complexity of the signal lines of the functional blocks, the average length of the signal lines and the interconnection line capacitance of the unit length of the signal lines can be achieved based on the functional block specification information.

Modeling of complexity of the signal lines of the functional blocks and modeling of an average length of the signal lines can be accomplished using the known method disclosed in the article entitled “An Accurate Interconnection Length Estimation for Computer Logic” by Stroobandt Dirk, Herwig Van Marck, Jan Van Compenhout in proceeding of Sixth Great Lakes Symposium on VLSI, pp 50-55, Mar. 22-23, 1996. Modeling of interconnection line capacitance can be achieved by the known method disclosed in the article entitled “Multilevel Metal Capacitance Models For CAD Design Synthesis Systems” by Jue-Hsien Chern, Jean Huang, Lawrence Arkedgem Ping-Chung Li and Ping Yang in IEEE Electron Device Letters, Vol. 13, No. 1, January 1992.

Power consumption of a corresponding functional block can be estimated using the complexity of the signal lines of the functional blocks, the average length of the signal lines and the interconnection line capacitance of the unit length of the signal lines in the step S50. The complexity of internal signal lines of a circuit and loading capacitance of an internal circuit are estimated using definition of inputs/outputs of the functional blocks and specifications about gate counts in order to estimate chip level power consumption in a state that an RTL (resistor transfer level) circuit is not defined, and switching probability of each signal line is estimated, to estimate the quantity of power consumption of the functional blocks. Power consumption of the functional blocks is represented as follows.
Ptotal=Psw+Pshort+Pleak

Here, Ptotal represents total power consumption of the functional blocks, and Psw denotes switching power of the functional blocks, that is, power consumption caused by switching of loading capacitance connected to output ports of internal logic circuits constructing the functional blocks. In addition, Pshort represents the short circuit power, which power consumption generated when a direct current path is formed between a power supply node and a ground node. P-type MOS transistor and an N-type MOS transistor are simultaneously operated when CMOS (Complementary Metal Oxide Silicon) logic circuits are switched, and Pleak denotes leakage power consumption caused by leakage current. The leakage current is generated due to imperfect current blocking characteristic of transistor in an inactive stage. The power consumption due to the leakage current cannot be ignored as a voltage applied to a circuit is decreased and integration of the circuit is abruptly increased.

The switching power of the functional blocks is represented as follows.
Psw=(Cloading*Vsupplyˆ2*Frequency*Switchingprob)/2

Here, Cloading is the total sum of output loading capacitance of all gates of the functional blocks, Vsupply is a power supply voltage applied to the circuit, Frequency is a clock frequency applied to the functional blocks, and Switchingprob represents average switching probability of internal logic circuits of the functional blocks.

In the estimation of power consumption of the functional blocks through the aforementioned method, functional block specifications should be examined or architecture design should be carried out again when a problem is generated due to power consumption of the functional blocks. In a normal case, bock placement is performed in consideration of the quantity of power consumption of the functional blocks and design power distribution network for the entire integrated circuit in the step S60.

After the block placement and power distribution network design, loading capacitance distribution of each functional block is modeled in order to analyze a voltage drop of a power distribution and current density in the step S70.

As described above, the present invention models complexity of output signal lines of logic gates and an average length of the signal lines using a statistical model based on circuit scale specifications represented by definition of inputs and outputs of functional blocks and the total number of the logic gates, and estimates distribution of loading capacitance of the logic gates using the modeling. The statistical modeling technique used in the present invention uses a table type distribution model using statistical data or an analytic model formula based on Rent's Rule.

To secure reliability of the generated model, a functional block is divided into lower blocks if the scale is larger than a criterion. For example, when the size of the functional block is larger than 100,000 gates it is divided into several blocks by size of criterion, and power consumption of the entire functional block in consideration of interconnection of the divided lower blocks is estimated to perform hierarchical modeling, thereby increasing accuracy of the model. That is, in the estimation of power consumption of an integrated circuit or a functional block, the functional block is divided into lower blocks by a criterion and power consumption of the lower blocks is estimated, and power consumption of the entire functional block is estimated in consideration of interconnection of the divided lower blocks.

Loading capacitance of each logic circuit is determined by semiconductor process characteristic to be applied to chip fabrication.

When complexity and fan-out distribution of output signal lines of an internal circuit of each functional block and the average length of the signal lines are estimated, switching power Psw of the functional block using switching probability given as design specifications can be estimated.

The present invention allows power consumption of the internal circuit of a virtually implemented functional block to be similar to power consumption of the actual circuit using a technique of defining complexity of signal lines and switching probability distribution of each signal line and allocating the complexity and switching probability distribution to each logic circuit. By doing so, the present invention designs a power distribution network considering layout effect in the final design process, and estimates and prevents a design error caused by an excessive voltage drop and excessive current density of the power distribution network in a design process prior to RTL in which detailed circuit information does not exist.

The method of defining switching probability according to circuit characteristic can use a distribution function that can be mathematically represented or a table type modeling method representing switching probability distribution for each individual element.

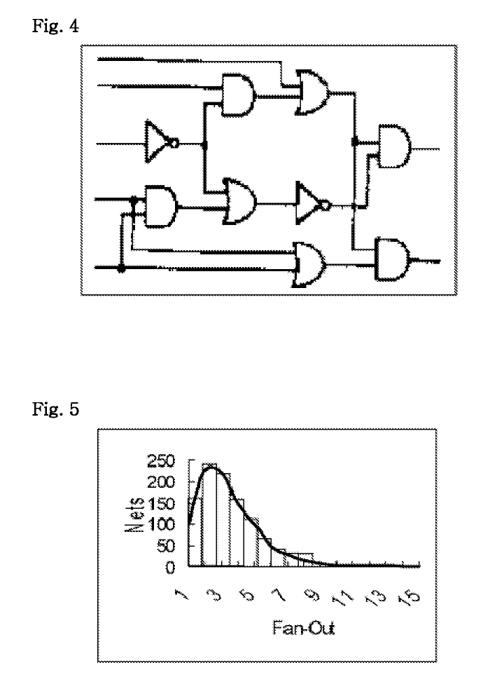

FIG. 4 illustrates interconnection of gate-level logic circuit elements constructing each functional block and nets representing interconnection of the logical circuit elements.

A complexity of a functional block is estimated by supposing signal line interconnection of logic circuits. When the number of inputs and outputs of the functional block shown in FIG. 4 is “nets”, the loading capacitance distribution of the logical circuit elements, as shown in FIG. 5, can be modeled using a modeling method based on Rent's Rule.

FIG. 5 is a graph showing distribution of output loading capacitance connected to the output of each of logical circuit elements constructing a functional block. The distribution of output loading capacitance is varied with circuit characteristic of the functional block.

In SOC or ASIC circuit design, the number of maximum allowable fan-out is restricted by the characteristic of a standard cell library and applied process.

The switching probability that determines power consumption of each logic circuit can be modeled as follows.
Ps(i)=(−1.0)/(SWaverg)*log(RandomNumber)

Here, SWaverg represents an average of switching probability of a functional block, Ps(i) represents switching probability of the ith logic circuit of a functional block that has an average switching probability of Swaverg and has an exponential density function, and RandomNumber represents a natural number between 0 and 1.

TABLE 1
[Example of distribution table]

| Switching probability | Number of logic |
|---|---|
| section | circuits |
| 0.0-0.1 | 500 |
| 0.1-0.2 | 2000 |
| 0.2-0.3 | 200 |
| 0.3-0.5 | 50 |
| 0.5-0.8 | 10 |
| 0.8-1.0 | 0 |

Accordingly, distribution of power consumption of each functional block can be modeled, and analysis of a voltage drop and current density at an internal node of each functional block can be carried out in a step prior to RTL circuit design (S80).

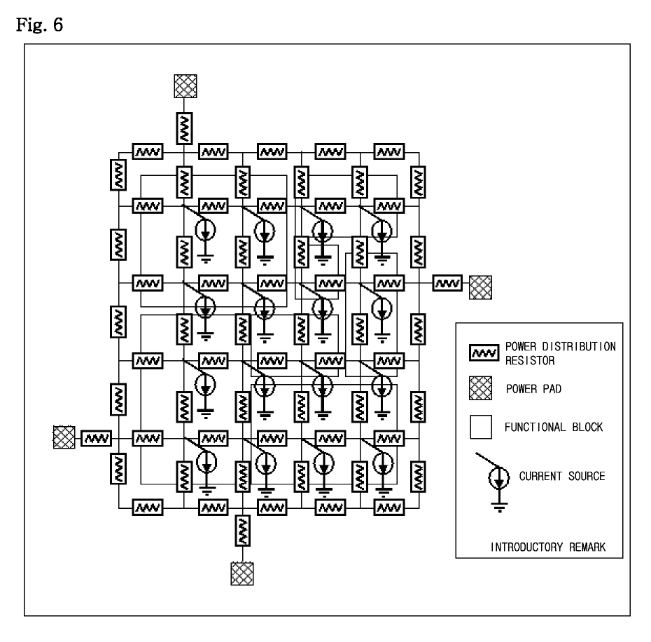

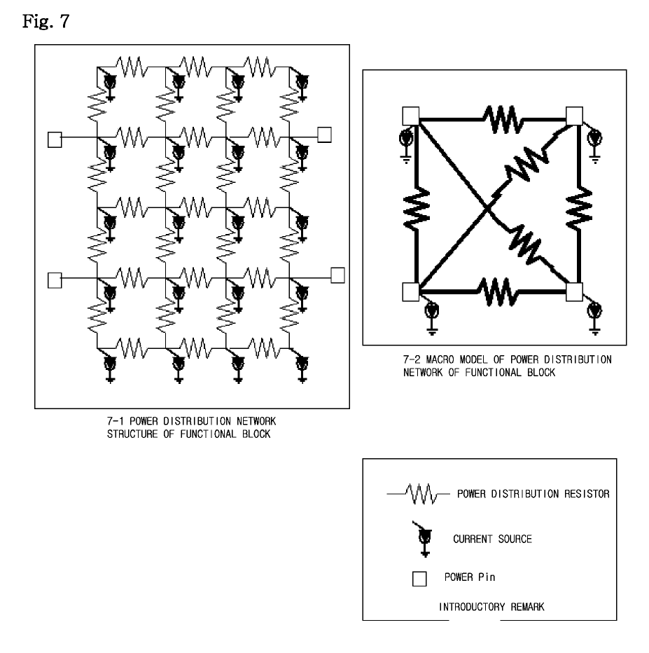

FIG. 6 illustrates placement of functional blocks and power distribution network routing according to the present invention. As shown in FIG. 6, a voltage drop of power network line is varied with placement of the functional blocks constructing an integrated circuit and the form of power distribution network providing power to the functional blocks. To estimate a voltage drop of a power distribution network in the functional block placement process, a linear circuit network composed of resistors of the power distribution network and a current source representing average power consumption in each logical circuit element is analyzed.

The voltage drop effect in the integrated circuit is rapidly estimated using a simplified power distribution network, as shown in FIG. 6, in the functional block placement process that is repeatedly carried out in order to minimize interconnection of functional blocks and the area of the functional blocks. That is, not only the area of the integrated circuit and timing but also distribution of power consumption and voltage drop are considered as design restriction factors for optimization of functional block placement.

The structure of a power distribution network of an integrated circuit is determined in a manner that a virtual interconnection line structure is decided according to functional block placement and a resistance value between nodes with respect to the power distribution network is extracted. Power consumption of each functional block is estimated from specifications defined by the number of inputs and outputs of the functional block and the number of logic gates, and a current value of each node is determined using the estimated power consumption.
Optimum functional block placement=f(area-factor,timing-factor,power-factor)

Here, f (area-factor, timing-factor, power-factor) represents a function of the area, signal line delay time and power consumption, area-factor represents the sum of the areas of all the functional blocks and the area of the margin between functional blocks, timing-factor represents signal transfer delay time factors of signal lines having interconnection with all the functional blocks, and power-factor represents distribution of node voltages and entire node voltage of power distribution network included in each functional block, that is, the quantity of power consumption for a unit area of each functional block.

The voltage of each node can be calculated as follows.
[V]=[R][I]
Here, [V] represents a matrix for node voltage, [I] denotes a matrix for a current source at each node, and [R] represents a matrix for resistance between each nodes.

In the meantime, macro modeling of functional blocks for hierarchical analysis of the power distribution network is performed. To efficiently carry out analysis of a power distribution network of SOC including functional blocks, it is very effective to use a hierarchical analysis method. Here, accuracy of a functional block macro model is very important to secure accuracy of the analysis result.

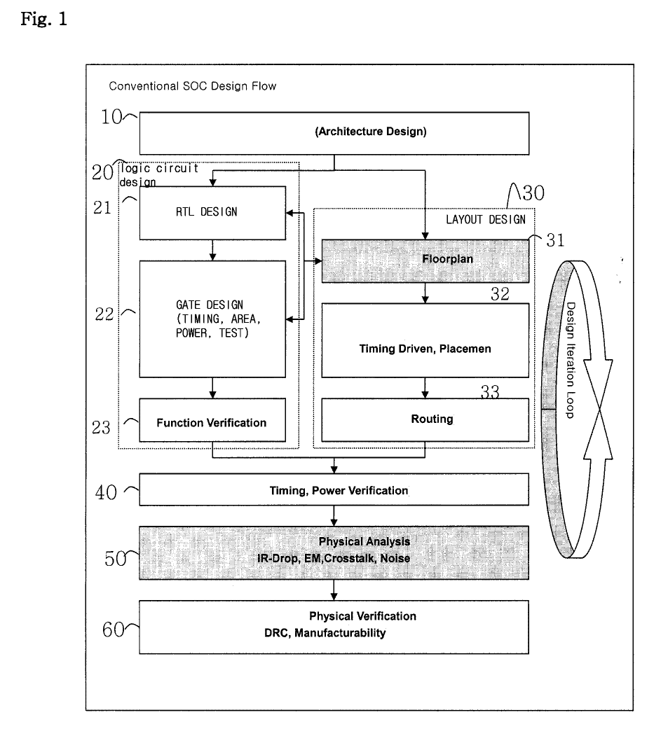

FIG. 7 illustrates macro models of a power distribution network of functional blocks and a power distribution network of a corresponding functional block. The basic concept of obtaining a macro model (FIG. 7-2) for the power distribution network of the functional block (FIG. 7-1) is to obtain mutual admittance matrix for each power port of the functional block.

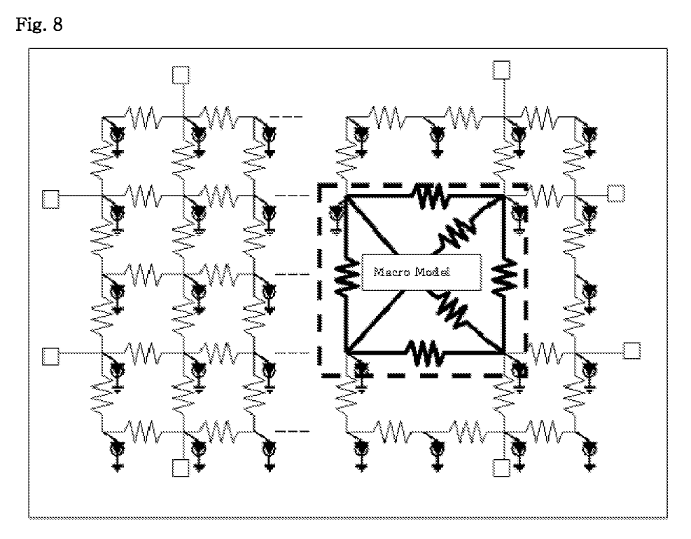

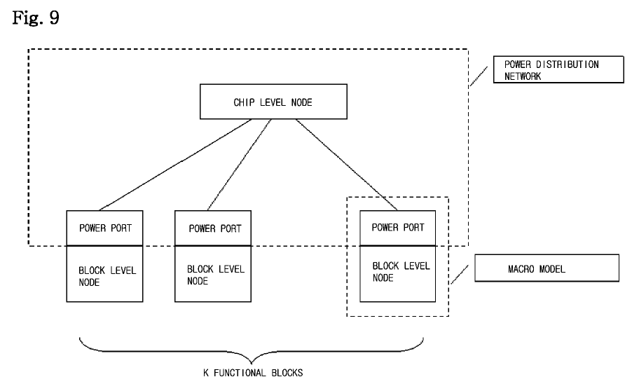

FIG. 8 illustrates a global network structure including a macro model of a power distribution network of functional block.

The power distribution network of an SOC includes a global network providing power from 10 pads to various functional blocks and a local network providing power to internal elements of the functional blocks.

FIG. 9 illustrates the concept of a global network structure having K functional blocks.

For hierarchical analysis of a voltage drop for the power distribution network of an SOC, a voltage drop in functional blocks on the assumption that ideal power is provided is analyzed, and a macro model of the power distribution network is constructed based on power ports of the functional blocks. Then, the voltage drop is analyzed in connection with the entire power distribution network.

The power distribution network analysis method proposed by the present invention is applied in the initial design step, and thus it employs a static analysis technique for a power distribution network structure composed of resistors. The solution of the power distribution network structure is obtained as follows.
GV=I

Here, G is conductance matrix, V is vector of unknown node voltages, and I is vector of current sources.

Accordingly, the present invention models power consumption and loading quantity distribution of functional blocks right after architecture design to solve a voltage drop and current density of power distribution network in an early stage, and then carries out layout design including functional block placement and power network routing.

### INDUSTRIAL APPLICABILITY

According to the present invention, detailed design of a power distribution network can be carried out in an early stage after architecture design, and thus initial functional block placement design in consideration of the area of an integrated circuit, timing and power consumption can be performed. Furthermore, it is possible to design a power distribution network in consideration of power consumption of functional blocks in the architecture design process corresponding to an initial integrated circuit design process. And, power distribution network design and analysis according to a variation in specifications of an integrated circuit can be performed without re-designing detailed circuits and layout. Moreover, unnecessary re-design work is minimized through estimation and prevention of a design error with respect to a power distribution network to remarkably reduce the design turn around time.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method for designing block placement and power distribution of a semiconductor integrated circuit, which designs a semiconductor integrated circuit through logical circuit design after architecture design, and simulation and physical verification after layout design,
wherein a reliability estimation process of power distribution network, which models complexity of the inside of each of functional blocks constructing the integrated circuit based on functional block specifications, estimates power consumption of each functional block to design block placement and power distribution network design for the entire chip, and analyzes reliability of power distribution network, such as a voltage drop and current density of power distribution network according to power consumption modeling of each functional block to estimate and verify reliability of power distribution network, is performed after architecture design, and then layout design is carried out.

2. The method for designing block placement and power distribution network of a semiconductor integrated circuit of claim 1, wherein the power distribution reliability estimation process comprises the steps of:
receiving functional block specification information, such as the number of inputs/outputs of functional blocks of an integrated circuit, the number of logic gates in the functional blocks, average switching probability, an operating voltage, and frequency, which are set by architecture design;
modeling complexity of signal lines of the functional blocks based on the functional block specification information;
modeling an average length of the signal lines of the functional blocks based on the functional block specification information;
modeling interconnection line capacitance of a unit length of the signal lines;
calculating the total loading capacitance based on the signal line complexity, the average length, and the interconnection line capacitance of the unit length and estimating power consumption based on the total loading capacitance;
designing functional blocks placement and power distribution network of the entire chip in consideration of a power consumption value of each functional block;
modeling power consumption distribution of each function block based on switching probability distribution with respect to virtual logic elements of each function block; and
analyzing a voltage drop of and current density of power distribution network at each node based on power consumption of each functional block.

3. The method for designing block placement and power distribution network of a semiconductor integrated circuit of claim 2, wherein the step of estimating power consumption of each functional block divides the functional block into lower blocks by predefined criterion according to the scale of the functional block, estimates power consumption of the lower blocks, and estimates power consumption of the entire functional block in consideration of interconnection of the divided lower blocks.

4. The method for designing block placement and power distribution network of a semiconductor integrated circuit of claim 2, wherein the step of designing functional block placement and power distribution networks routing constructs and analyzes a virtual power distribution network using functional block placement information to optimize functional block placement in order to consider a voltage drop of a power distribution network in the functional block placement process.

5. The method for designing block placement and power distribution network of a semiconductor integrated circuit of claim 2, wherein the step of modeling power consumption distribution of each functional block models loading capacitance and switching probability distribution of each logical element included in each functional block based on the number of maximum allowable fan-outs restricted by characteristic of a standard cell library and applied process.
